(19) United States
(12) Patent Application Publication
(10) Pub. No.: US 2016/0007062 A1
(43) Pub. Date: Jan. 7, 2016

(54) BROADCAST CONTENT MANAGEMENT BASED ON CATEGORIZATION

(71) Applicants: Mark Francis RUMREICH, Indianapolis, IN (US); Chad Andrew LEFEVRE, Indianapolis, IN (US); Michael Scott DEISS, Zionsville, IN (US); Thomson Licensing, Issy les Moulineaux (FR)

(72) Inventors: Mark Francis RUMREICH, Indianapolis, IN (US); Chad Andrew LEFEVRE, Indianapolis, IN (US); Michael Scott DEISS, Zionsville, IN (US)

(73) Assignee: Thomson Licensing, Issy de Moulineaux (FR)

(21) Appl. No.: 14/770,050

(22) PCT Filed: Mar. 28, 2013
(86) PCT No.: PCT/US13/34263

§ 371 Date: Aug. 24, 2015

(51) Int. Cl. H04N 21/2665; H04N 21/262; H04N 21/24; H04N 21/235; H04N 21/2365

(52) U.S. Cl. CPC H04N 21/2665; H04N 21/2353; H04N 21/2365; H04N 21/2402; H04N 21/2407; H04N 21/26275; H04N 21/26216; H04N 21/26241

(57) ABSTRACT

A method for a content provider to manage broadcast content including selecting content to be broadcast, determining a category of the selected content, tagging the selected content and transmitting the tagged selected content to a content aggregator for broadcasting. Also described is a method for a content aggregator to broadcast content including receiving selected content from a content provider, determining when to broadcast the selected content and determining whether to broadcast any part of the selected content prior to a schedule time and broadcasting the selected content responsive to the determining step.

### FIELD OF THE INVENTION

The present invention relates to a content management system that allows delivery of program content in several time frames while also managing the user's available viewing of the program content based on a categorization of the content.

### BACKGROUND OF THE INVENTION

In multicast and broadcast applications, data are transmitted from a server to multiple receivers over wired and/or wireless networks. A multicast system as used herein is a system in which a server transmits the same data to multiple receivers simultaneously, where the receivers form a subset of all the receivers up to and including all of the receivers. A broadcast system is a system in which a server transmits the same data to all of the receivers simultaneously. That is, a multicast system by definition can include a broadcast system.

Kwon describes advance delivery with a scheduled playback time but has no advance viewing. The advance delivery of Kwon is only in the context of augmentation information not the entire content. Merrill, Wiser, Watson and Song describe time opportunistic content delivery in non-real time. Merrill describes non-real time delivery of content with real-time viewing of the content. Wiser describes broadcasting some of the content and using methods other than broadcast, such as unicast, for delivery of other portions of the content. Wiser enables an affiliate that has received at least a portion of corrupted or missing programming content to repair or reconstruct the programming content before distributing or broadcasting to viewers, by forming a peer to peer network among the affiliates and the affiliate and broadband distribution system. Watson provides viewers access to a library of movies, or any other audio/video content available for viewing at anytime. The content is pushed by the service provider to set top boxes in users's premises and available for a specified period of time. Song provides for non-real time (time opportunistic) transfer of content to a user (user's premises) for later real-time reproduction. No known prior art teaches or suggests advance delivery with a scheduled playback time and advance viewing permitted.

As used herein program content (also simply called “content” herein) may be audio content, video content or a combination of audio and video content or may be multimedia content of any sort that can be broadcast, multicast or unicast over wireless or wired lined communication systems. New broadcast content delivery mechanisms permit delivery of program content at a rate faster than it is consumed. Some content may be advantageously delivered at off-peak times. However, some content may need to be controlled so that an earlier receipt of the content does not necessarily also allow earlier consumption. Such a scenario exists with content that is delivered for a wide audience to provide feedback (e.g., reality or game/contest shows or season premieres). The present invention provides a solution to this type of problem.

### SUMMARY OF THE INVENTION

New approaches to broadcast content delivery mechanisms (e.g., ATSC 3.0) permit delivery of content in more than one timing scenario. The present invention relates to a content management system that allows delivery of content in several time frames while also managing the user's available viewing of the content based on a categorization of the content.

A method for a content provider to manage broadcast content including selecting content to be broadcast, determining a category of the selected content, tagging the selected content and transmitting the tagged selected content to a content aggregator for broadcasting. Also described is a method for a content aggregator to broadcast content including receiving selected content from a content provider, determining when to broadcast the selected content and determining whether to broadcast any part of the selected content prior to a schedule time and broadcasting the selected content responsive to the determining step.

### BRIEF DESCRIPTION OF THE DRAWINGS

The present invention is best understood from the following detailed description when read in conjunction with the accompanying drawings. The drawings include the following figures briefly described below:

FIG. 1 is a schematic diagram of a broadcast system that may utilize the present invention.

FIG. 2A is a flowchart of the exemplary operation of a content provider in accordance with the principles of the present invention.

FIG. 2B is a flowchart of the exemplary optional operation of a content provider in accordance with the principles of the present invention.

FIG. 3 is a flowchart of the exemplary operation of a content aggregator in accordance with the principles of the present invention.

FIG. 4 is a block diagram of an exemplary content provider in accordance with the principles of the present invention.

FIG. 5 is a block diagram of an exemplary content aggregator in accordance with the principles of the present invention.

### DETAILED DESCRIPTION OF THE PREFERRED EMBODIMENTS

The new ATSC 3.0 standard is being discussed and worked on with the goal of broadening connectivity in home and at the link layer. Other goals include audio and video compression. ATSC 3.0 is also looking at variations of MPEG. The goal is to capture or re-capture the broadcast audience. A digital connection, such as a network connection between the Internet and the receiver device would be useful for the user.

The principal thrust is for in home devices rather than small (mobile) devices. The present invention may further take advantage of the broadcasters cooperating together using a single orthogonal frequency-division multiplexing (OFDM) band. In such a broadcast network, a plurality of transmitters simultaneously broadcast the same signal over the same frequencies. This would give broadcasters a very large shared channel and, using the currently available broadcast antennas, improve multipath insensitivity. This would have the effect of essentially making the broadcasters into content providers and possibly create a new entity whose sole purpose was to transmit the content supplied by the broadcasters (content providers) over the single channel. This would have the further effect of increasing the bandwidth available to each of the broadcasters (content providers). Such a scheme would also eliminate co-channel issues as well as near/far issues. Near/far issues result in some markets because transmission (broadcast) antenna placement may be too far for some customers. In such a situation, customers (users/receivers) living on one side of town receive broadcast transmissions from certain channels but may want to view other channels having transmission (broadcast) antennas on the other side of town to no avail. The content aggregator would be the new entity, the ownership of which might be vested in the content providers based on some equitable arrangement such as audience share. Legal issues would have to be addressed.

As a result, the content delivery mechanism may be able to deliver media content at a rate that easily exceeds the consumption rate of consumers. In other words, non-real time content (regular television programming) could be delivered (broadcast) to customer premises, which may include businesses, earlier than the scheduled time slot. Some content must remain delivered in real time (sports events, news). Still other content may be delivered ahead of time but not consumed (available to the user) until the scheduled time slot (reality shows, games, contests, and the like which involve audience participation). Finally, still other programming may be delivered untimed, or opportunistically. The user is then notified that this programming is available. The entire structure also relies on a media storage system, such as a hard drive, in order to “temporarily” store and maintain the delivered content. The content may also be delayed in consumption if desired. Content could be tagged in some manner based on the four possible categories. Tagging, for example, may be metadata or part of the program description.

The four categories are:
Real time content—delivery is at the time of consumption. Content consumption is the same as content playback, rendering or viewing. No modification is made to the content for the purpose of limiting the time of consumption by the receiver. Content could be altered, however, for other purposes, such as
   transcoding for the purpose of setting a targeted transmission bit rate
   transcoding for the purpose of adding video overlays
   insertion of additional data to enable the faster signal acquisition and presentation at the receiver, for benefit of improved channel change.
Effective real time content—delivery may be done, either completely or partially, before and up to the scheduled time of consumption. Playback is permitted only at (or after) a scheduled time. The content can be altered before transmission in such a way as to prevent decoding and presentation at the receiver for viewing by the user, until timely reception of essential information used to complete the decoding and presentation process. Examples include (but are not limited to):
   timely delivery of keys for decryption of encrypted content. Transmission of such keys are delayed until viewing is permitted.
   delaying transmission of certain portions of content data (time re-ordering of data) thus preventing decoding and presentation at the receiver of a useful part of the content data. Until such time that viewing is permitted, all essential content data is finally transmitted and the receiver properly orders the previously re-ordered transmitted content data permitting the content data to be successfully parsed at the receiver.
Non-real time content—delivery may be done at any time before and up to the scheduled time of consumption. Playback or consumption may be permitted once the content is delivered. In another embodiment, playback or consumption may be permitted before the content is fully delivered, typically with a notification to the user that the playback or consumption may stop if the delivery is not complete. This could involve a premium (paid fee) and may be protected in some manner. The fee would be paid if viewing earlier than the scheduled time slot is selected by the user (e.g., for season premieres) or if the program content is not scheduled but is a special feature. Billing could be through the customer's telephone bill or a Paypal type account or prepaid accounts (including gift cards) or credit cards. The content may also be delivered, and then not played back until the scheduled time slot. An advantage is that bandwidth is freed up for other programming at a regular scheduled time slot, while the non-real time content may be delivered at a nonpeak (i.e. overnight) time.
Time opportunistic content—delivery is done as the bandwidth is made available. Once the content is delivered completely, the content is made available for consumption. In another embodiment, playback or consumption may be permitted before the content is fully delivered, typically with a notification to the user that the playback or consumption may stop if the delivery is not complete. Such content is not scheduled. Such content may be things like documentaries, infomercials, etc. Time opportunistic content may be offered as Pay-Per-View, or as a library of available programs available to watch at any time. Once again various billing arrangements are possible for Pay-Per-View such as telephone accounts, Paypal type accounts or prepaid type accounts or credit cards.

TABLE 1
content types

| | | advance | scheduled | advance |
|---|---|---|---|---|
| | | trans- | play | viewing |
| content type | description | mission? | backtime? | allowed? |
| real time | delivery at time of | N | Y | N |
| | consumption | | | |
| effective real | advance delivery | Y | Y | N |
| time | before scheduled | | | |
| | time of consumption | | | |
| non-real time | advance delivery | Y | Y | Y |
| | before scheduled | | | |
| | time of consumption. | | | |
| | Consumption permit- | | | |
| | ted once the content | | | |
| | is delivered | | | |
| time | delivery as bandwidth | Y | N | n/a |
| opportunistic | is available | | | |

Supplementing the aggregation of content through a network interface is also a possibility. Possible interfaces include wired or wireless Ethernet and Multimedia over Coax Alliance (MoCA). If networking interfaces are available, it could be possible to speed up the downloading of content by using these interfaces in addition to the wideband tuner that is used to gather the terrestrial broadcast data. If networking interfaces are available and connected, they could be put to use, though they would have to be supplemental interfaces due to the nature of the customer premises equipment (CPE) (e.g. if the user does not have access to the Internet, the CPE would still need to function in the way described in this document). There is also the possibility that an interface exists and is connected but is currently in use for another purpose (e.g. watching a video from the home network over Digital Living Network Alliance (DLNA)).

The media storage system (e.g. HDD) would need to have some sort of management system (most likely driven by the UI of the EPG) to maintain recorded material for later viewing. Unlike a traditional PVR, much of the content in this system would be recorded by the system in order to fulfill future programming (effective real time and non-real time content) and “on demand” programming (opportunistic content) needs. In the case where the storage system space is limited, there is a need to manage the deletion of unwanted content. This could be done using a conventional algorithm, based on content type and status (whether the program in question has already passed its timeslot requirements or the oldest “on demand” content that has been stored). In addition, it may be possible to provide to the user the ability to flag what types of content to keep or delete, based on content metadata (such as genre) or even based on program or episode title. It may be possible to give the user as much or as little control as desired by the management system creator. There are many limitations regarding what may be recorded, including but not limited to: total space of the storage system; available space on the storage system; and availability of interfaces to get data from (in the case of limits on the available bandwidth of the wideband tuner or availability of a networking interface to supplement data loading). Management storage system(s) may be made available free as downloads or for a nominal fee or a monthly fee.

The data coming into the CPE could also contain supplemental information, possibly in the form of additional packet headers or as proprietary/open EPG data. This information could contain fields that help the storage system such as the dates of broadcast (which could be helpful to tell when non-real time or opportunistic content will be finished loading), the dates/times when the content is to be displayed (including the first time of display as well as future times of display, which can be used to determine when content is free to be deleted instead of deleting and re-downloading content for a future display). This will also help to keep fragmentation down on the storage system. Even a date/time that the broadcaster (content provider) wishes the CPE to stop storing the content (potentially requiring deletion regardless of the CPE's own storage settings) can override the CPE management storage system.

In the case of non-real time and effective real time content, it is very likely that it will be required to rebroadcast the content at the time the program is intended to be “live.” If there is an error in the storage procedure, it should still be possible for the user to watch a show that is listed in the EPG, just as they do now. If the program has already been recorded, the rebroadcast packets may be dropped and the program watched from the storage medium or the program may be watched live but not re-recorded or the program may be watched live and re-recorded and the previous recording deleted. This may be an interesting scenario due to the possibility that different advertising may be included at different broadcast times.

The broadcast procedure may be done using an algorithm to determine when a program is broadcast. It is quite likely that the same program may be broadcast many times in order to mitigate any issues in the recording process. It is possible that some content may be rebroadcast more than others, based on the preference of the broadcasters (shows that the broadcaster wants to make sure are properly recorded) or based upon some sort of perceived interest level, which could change based upon geographic location, for example. A program about hockey may be rebroadcast more often in the northern half of the country where the sport is more popular. There may be other rebroadcasting algorithms as well, and the possibility of no rebroadcasting at all.

The design of the system will have to take into account limits on the various parts of the system. In particular, there are limits on the size/speed of the storage medium, limits on the amount of data that can be broadcast, limits on the types of broadcast (different systems could use different modulation methods, all of which the CPE could support—true for TV tuners now), limits on the bandwidth of the tuner(s), and limits on the processor in the CPE in general. The system as a whole will have to take these limits into account and provide a base set of specifications that must be met in order to comply. Things like the content management algorithm mentioned above would help these “base” systems, while systems that exceed the base will have more ability, much the same as many current consumer electronics products.

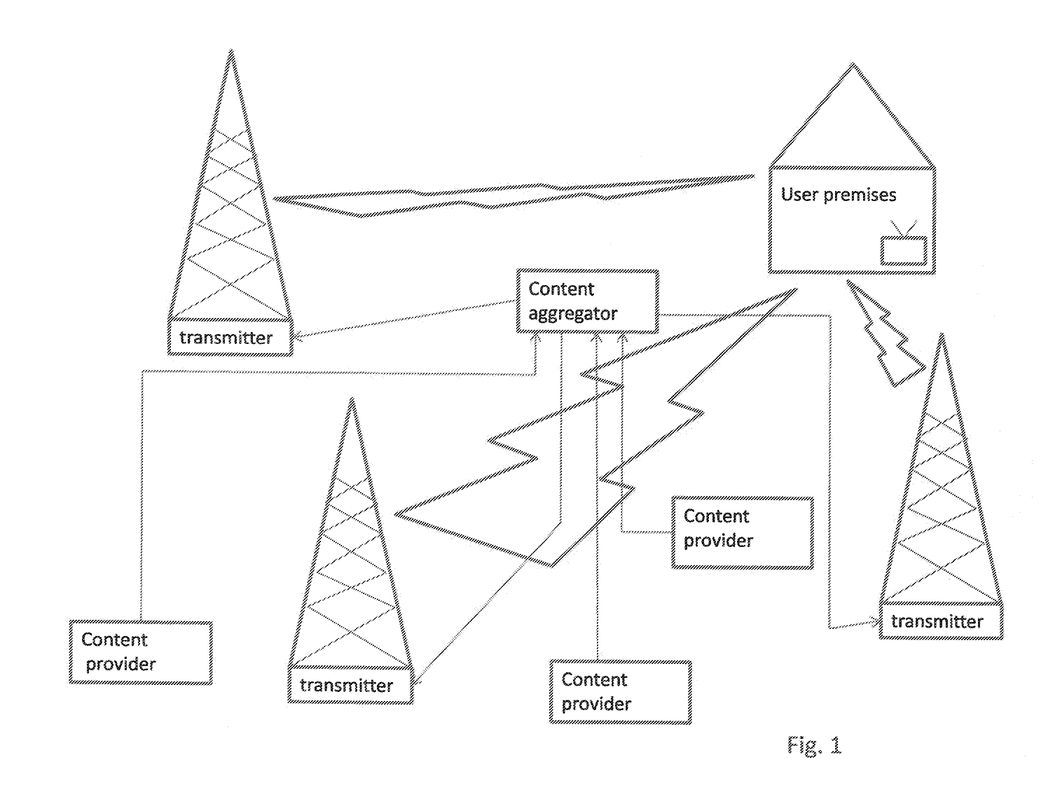

FIG. 1 is a schematic diagram of a broadcast system that may utilize the present invention. As can be seen from FIG. 1, the content aggregator receives content from the various content providers and transmits it to the transmission (broadcast) antennas for broadcasting to the customer's/user's premises, where premises may include businesses. The CPE is a device having additional storage and a storage management system, such as a TV, STB, computer, iPhone, iPod, iPad, dual mode smart phone, tablet or any other mobile device having means for receiving a broadcast signal such as described herein.

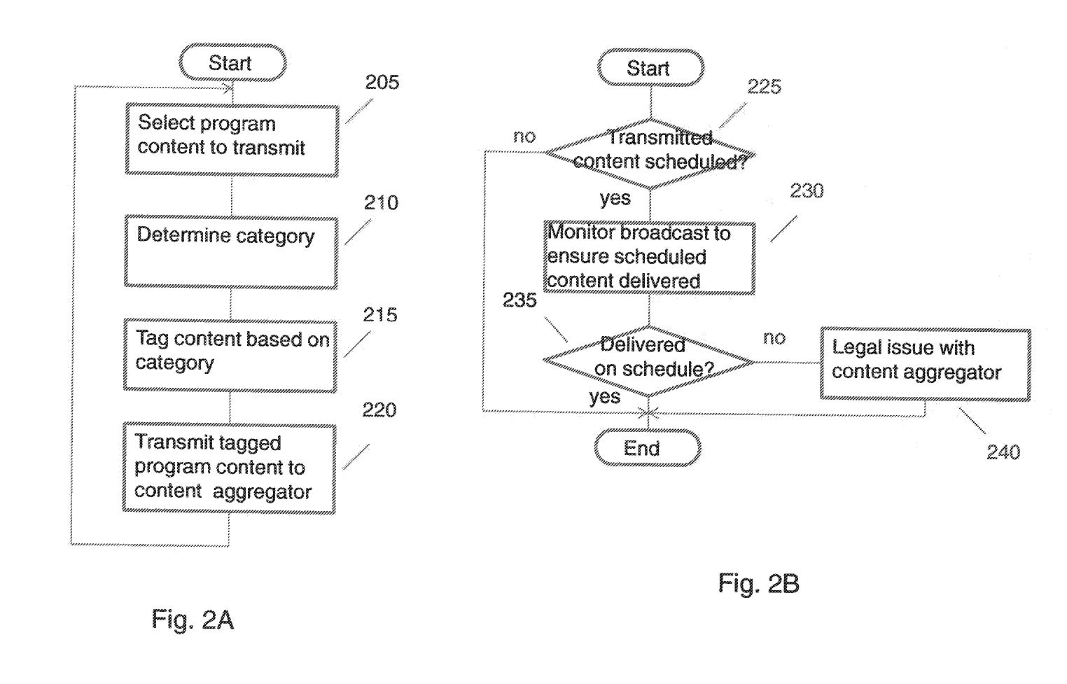

FIG. 2A is a flowchart of the exemplary operation of a content provider in accordance with the principles of the present invention. At 205 the content provider selects content to be transmitted to the content aggregator. The selection may be based on popularity of the content or some other criteria. At 210 the content provider determines the category of the content and when it needs to be broadcast. At 215, the content provider tags the content based on the category. Such tagging may involve multiple “tags”. For example, there may be a first tag to indicate whether advance transmission is possible. There may be a second tag to indicate when playback is permitted (whether content is scheduled for a particular time slot). There may be a third tag to indicate whether advance viewing is permitted (and under what conditions—perhaps including a fee). The above tags are, of course, in addition to rating and parental control information as well as information regarding genre, program or episode title.

FIG. 2B is a flowchart of the exemplary optional operation of a content provider in accordance with the principles of the present invention. This is optional because it is not a necessary function but it would be prudent for a content provider to monitor the broadcasts in order to ensure that the content aggregator is meeting its legal and contractual requirements in terms of broadcasting a content provider's content. At 225, the content provider determines if content was scheduled in a particular time slot. If not, then this part of the program can end. Actually, the content provider, using CPE, may request the content and see if it can be played/viewed. If the selected content was scheduled then at 230, the content provider monitors the time slot to ensure that the selected content was delivered in the scheduled time slot. At 235 a test is performed to determine if the selected content was delivered on schedule. If the selected content was delivered on schedule, then processing ends. If the selected content was not delivered on schedule (in the scheduled time slot), then there are legal and contractual issues that will need to be addressed.

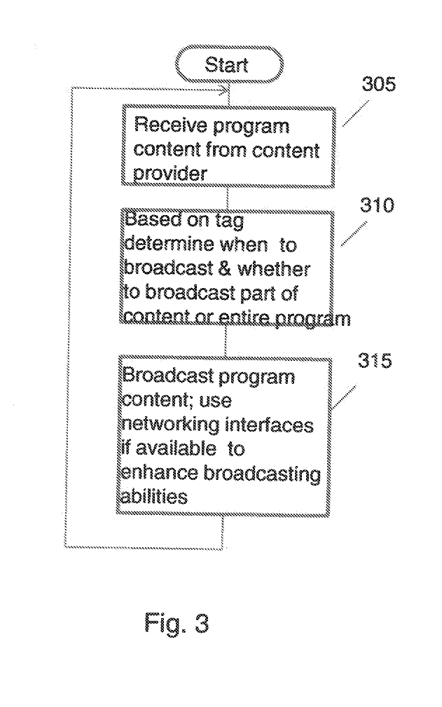

FIG. 3 is a flowchart of the exemplary operation of a content aggregator in accordance with the principles of the present invention. At 305, the content aggregator receives content from a content provider. At 310, based on the tag(s), the content aggregator determines when to broadcast the content and whether to broadcast the entire content (program) or part of the program. At 315 the content aggregator broadcasts the content and may use networking interfaces if networking interfaces are available in order to enhance broadcast capabilities. It is possible that the content may be made available to networking interfaces before any of the content is actually broadcast by the content aggregator, allowing a user to force a download of content. If networking interfaces are used then the content aggregator may modify the program content to provide additional data to aid the management storage system on the CPE as described above. Another form of data tagging may be used by the content provider or the content aggregator to provide a uniform resource locator (URL) or the like for accessing content on servers of the content provider or the content aggregator.

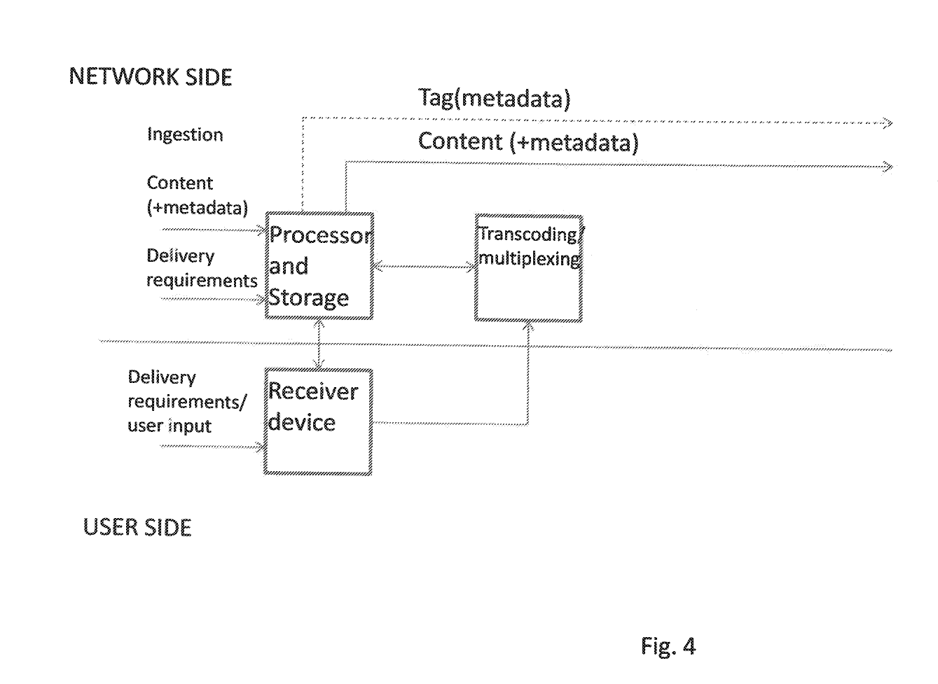

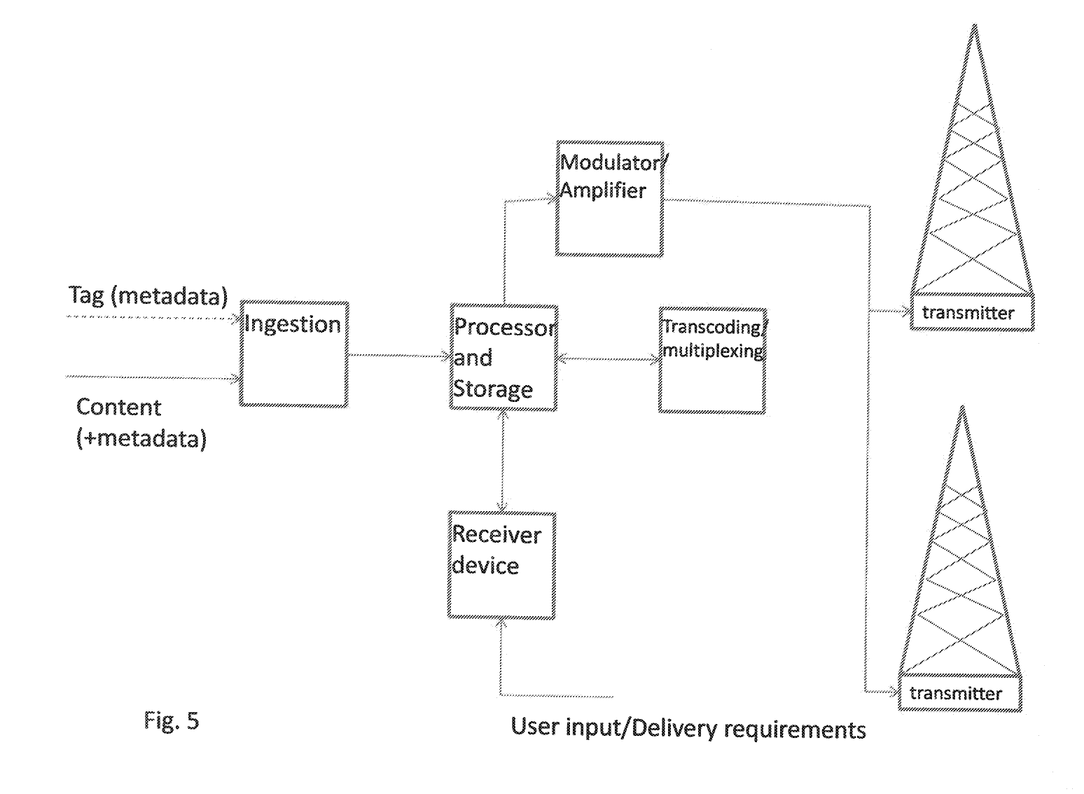

FIG. 4 is a block diagram of an exemplary content provider in accordance with the principles of the present invention. At the content provider premises there is a administrator input device for administrator input. The administrator inputs delivery requirements and any other input the administrator may have. The term “delivery requirements” refers to requirements for the delivery of content. The receiver device is in communication bi-directionally with the processor and storage module. The storage portion of the processor and storage module includes but is not limited to any form of storage such as optical discs, hard drives, traditional memory, RAM, FLASH, compact discs etc. The processor and storage module receives input on the network side in the form of content that may or may not have metadata. The option of having metadata is indicated by the parentheses. The processor and storage module also receives network side delivery requirements. The processor and storage module includes means for selecting content to be broadcast, means for determining a category of the selected content, means for tagging the selected content and means for transmitting the tagged selected content to the content aggregator. The processor and storage module is in bidirectional communication with the transcoding/multiplexing module. The transcoding/multiplexing module also receives input (delivery requirements/user input) from the administrator input device. In another embodiment, the trancoding/multiplexing module includes means for tagging the selected content. The storage device interfaces with (is in communication with) the content aggregator (broadcaster) shown in FIG. 5. The processor and storage module of the content provider of FIG. 4 outputs content (which may or may not contain embedded tags/metadata) and optionally standalone tags/metadata to the content aggregator. The processor and storage module of the content provider may also optionally output tags and/or metadata to the content aggregator. The processor and storage module of the content provider also optionally includes means for determining if the selected content was transmitted to the content aggregator, means for monitoring a broadcast channel, and means for determining if the selected content was broadcast according to a scheduled time. Tags may be provided by the content provider or the content aggregator. Tags may also be provided by the content provider and reformatted (modified) by the content aggregator. A horizontal line delineates the administrator side from the network side.

FIG. 5 is a block diagram of an exemplary content aggregator in accordance with the principles of the present invention. As indicated above, the ingestion module of the content aggregator receives content (which may or may not contain embedded tags/metadata) and optionally standalone tags/metadata from the content provider. The ingestion module may also optionally receive tags and/or metadata from the content provider. Tags may be provided by the content provider and/or the content aggregator. Tags may also be provided by the content provider and reformatted (modified) by the content aggregator. The ingestion module provides input to the processor and storage module. The storage portion of the processor and storage module includes but is not limited to any form of storage such as optical discs, hard drives, traditional memory, RAM, FLASH, compact discs etc. The processor and storage module is in bi-directional communication with the transcoding/multiplexing module. The processor and storage module includes means for receiving selected content from a content provider, means for determining when to broadcast the selected content and means for determining whether to broadcast any part of the selected content prior to a schedule time and means for broadcasting the selected content responsive to the means for determining. The processor and storage module also includes means for tagging the selected content if the selected content is received without any tags and means for modifying the tags associated with the selected content based on the means for determining. In another embodiment, the transcoding/multiplexing module includes means for tagging the selected content. The processor and storage module provides the stored content (and optionally metadata) to a modulator/amplifier, which forwards the content (and optionally metadata) to the transmitters. There is at least one transmitter and usually there is a plurality of transmitters. The administrator input device receives administrator input, including delivery requirements.

It is to be understood that the present invention may be implemented in various forms of hardware, software, firmware, special purpose processors, or a combination thereof. Special purpose processors may include application specific integrated circuits (ASICs), reduced instruction set computers (RISCs) and/or field programmable gate arrays (FPGAs). Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method for a content provider to manage broadcast content, said method comprising:
selecting content to be broadcast;
determining a category of said selected content, wherein said category is at least one of real time content, effective real time content, non-real time content and time opportunistic content;
tagging said selected content; and
transmitting said tagged selected content to a content aggregator for broadcasting, wherein said content aggregator receives content from the various content providers and forwards said content to transmission antennas for broadcasting to customers' premises, and further, wherein ownership of said content aggregator is vested in said content providers.

2. The method according to claim 1, wherein said tagged selected content includes tags as part of the content.

3. The method according to claim 1, wherein said tagged selected content includes tags separately from the content.

4. (canceled)

5. The method according to claim 1, where real time content is delivered at a time of consumption.

6. The method according to claim 1, where effective real time content may be delivered either completely or partially before and up to a time of consumption but consumption is permitted only at or after a scheduled time.

7. The method according to claim 1, where non-real time content is delivered at any time before and up to a scheduled time of consumption and consumption is permitted once the non-real time content is delivered.

8. The method according to claim 1, where non-real time content is delivered at any time before and up to a scheduled time of consumption and consumption is permitted before the non-real time content is fully delivered.

9. The method according to claim 1, where time opportunistic content is delivered as the broadcast bandwidth is made available and consumption is permitted once the time opportunistic content is delivered.

10. The method according to claim 1, where time opportunistic content is delivered as the broadcast bandwidth is made available and consumption is permitted before the time opportunistic content is fully delivered.

11. The method according to claim 1, further comprising:
determining if said selected content was transmitted to said content aggregator;
monitoring broadcast channel;
determining if said selected content was broadcast according to a scheduled time; and
taking appropriate alternative action if said selected content was not broadcast at said scheduled time.

12. A method for a content aggregator to broadcast content, said method comprising:
receiving selected content from a content provider;
determining when to broadcast said selected content and determining whether to broadcast any part of said selected content prior to a schedule time; and
broadcasting said selected content responsive to said determining step.

13. The method according to claim 12, wherein said broadcasting step includes using network interfaces, if available, to enhance broadcasting abilities.

14. The method according to claim 12, wherein said determining step is accomplished based on tags associated with said selected content.

15. The method according to claim 12, further comprising tagging said selected content if said selected content is received without any tags.

16. The method according to claim 15, further comprising modifying said tags associated with said selected content based on said determining step.

17. A content provider to manage broadcast content, comprising:
a processor and storage module, said processor and storage module selecting content to be broadcast;
said processor and storage module determining a category of said selected content, wherein said category is at least one of real time content, effective real time content, non-real time content and time opportunistic content;
said processor and storage module or a transcoding/multiplexing module, which is in bi-directional communication with said processor tagging said selected content; and
said processor and storage module transmitting said tagged selected content to a content aggregator for broadcasting, wherein said content aggregator receives content from the various content providers and forwards said content to transmission antennas for broadcasting to customers' premises, and further, wherein ownership of said content aggregator is vested in said content providers.

18. The content provider according to claim 17, where tagged selected content includes tags as part of the content.

19. The content provider according to claim 17, where tagged selected content includes tags separately from the content.

20. (canceled)

21. The content provider according to claim 17, where real time content is delivered at a time of consumption.

22. The content provider according to claim 17, where effective real time content may be delivered either completely or partially before and up to a time of consumption but consumption is permitted only at or after a scheduled time.

23. The content provider according to claim 17, where non-real time content is delivered at any time before and up to a scheduled time of consumption and consumption is permitted once the non-real time content is delivered.

24. The content provider according to claim 17, where non-real time content is delivered at any time before and up to a scheduled time of consumption and consumption is permitted before the non-real time content is fully delivered.

25. The content provider according to claim 17, where time opportunistic content is delivered as the broadcast bandwidth is made available and consumption is permitted once the time opportunistic content is delivered.

26. The content provider according to claim 17, where time opportunistic content is delivered as the broadcast bandwidth is made available and consumption is permitted before the time opportunistic content is fully delivered.

27. The content provider according to claim 17, further comprising:
said processor and storage module determining if said selected content was transmitted to said content aggregator;
said processor and storage module monitoring broadcast a channel;
said processor and storage module determining if said selected content was broadcast according to a scheduled time; and
an administrator device taking appropriate alternative action if said selected content was not broadcast at said scheduled time.

28. A content aggregator for broadcasting and managing content, comprising:
a processor and storage module, said processor and storage module receiving selected content from a content provider;
said processor and storage module determining when to broadcast said selected content and means for determining whether to broadcast any part of said selected content prior to a schedule time; and
said processor and storage module broadcasting said selected content responsive to said determining.

29. The content aggregator according to claim 28, wherein said broadcasting includes using network interfaces, if available, to enhance broadcasting abilities.

30. The content aggregator according to claim 28, wherein said determining is accomplished based on tags associated with said selected content.

31. The content aggregator according to claim 28, further comprising said processor and storage module or a transcoding/multiplexing module in bi-directional communication with said processor and storage module tagging said selected content if said selected content is received without any tags.

32. The content aggregator according to claim 30, further comprising said processor and storage module modifying said tags associated with said selected content based on said determining.
